(19) United States
(12) Patent Application Publication
(10) Pub. No.: US 2024/0397439 A1
(43) Pub. Date: Nov. 28, 2024

(54) BASE STATION WITH ADAPTIVE COVERAGE

(71) Applicants: INDIAN INSTITUTE OF TECHNOLOGY HYDERABAD, Kandi (IN); WISIG NETWORKS PRIVATE LIMITED, Madinaguda (IN)

(72) Inventors: Kiran Kumar KUCHI, Madinaguda Hyderabad (IN); Saidhiraj AMURU, Kandi (IN); Koteswara Rao GUDIMITLA, Kandi (IN); Subhash KUMAWAT, Kandi (IN); Pavan Kumar Reddy MANNE, Kandi (IN); Sibgath Ali Khan MAKANDAR, Kandi Sangareddy (IN); Harish Kumar DUREPPAGARI, Kandi (IN)

(21) Appl. No.: 18/795,586

(22) Filed: Aug. 6, 2024

Related U.S. Application Data
(63) Continuation of application No. 18/017,730, filed on Jan. 24, 2023.

(30) Foreign Application Priority Data
Aug. 7, 2020 (IN) 202041034036
Jan. 18, 2021 (IN) 202141002324
Apr. 5, 2021 (IN) 202141016054

(51) Int. Cl. H04W 52/26; H04W 72/1263

(52) U.S. Cl. CPC H04W 52/262; H04W 72/1263

(57) ABSTRACT

Embodiments of the present disclosure are related, in general to communication, but exclusively related to methods and systems for improving coverage of a cellular network. The method comprising obtaining a transmission power capability of a user equipment (UE), and determining a time-frequency opportunities allocated to the UE and a modulation and coding scheme (MCS) associated with the UE. Thereafter, indicating an increase in the instantaneous transmit power level to the UE based on the transmission power capability of the UE, the time-frequency opportunities and the associated MCS. The method also comprises obtaining the number of Resource Elements (REs) available for PUSCH transmission. A Transport Block Size is obtained for the REs obtained and is transmitted by adding Cyclic Redundancy Check. The procedure also includes the usage of uplink symbols in special slots. The method also comprising the usage of Reference Symbols across the transmission opportunities based on the UE capability.

### CROSS-REFERENCE TO RELATED APPLICATIONS

This application claims priority from the Indian Provisional Patent Application Numbers i) 202041034036, filed on 7 Aug. 2020: ii) 202141002324 filed on 18 Jan. 2021; iii) 202141016054 filed on 5 Apr. 2021, the entirety of which are hereby incorporated by reference.

### TECHNICAL FIELD

Embodiments of the present disclosure are related, in general to communication, but exclusively related to methods and systems for improving coverage of a cellular network.

### BACKGROUND

Coverage expansion especially for rural use cases has been a major requirement of rural deployment for several years. This requirement stems from a largescale rural deployment envisaged for 5th generation (5G) applications. The current deployments may adopt 5G NR for both rural and urban use cases, in the available 5G New Radio (NR) bands including the 3.3-3.6 GHz band. The 3GPP specifications should aim to maximize the coverage for 3.3-3.6 GHz TDD band as well sub GHz FDD, e.g., 700 MHz bands.

Low-Mobility-Large-Cell (LMLC) for rural coverage has been specified by the International Telecommunication Union (ITU) as a mandatory requirement for International Mobile Telecommunications-2020 (IMT-2020) specifications. Though LMLC evaluations specify 6 Km ISD at 700 MHz carrier frequency, the actual deployment scenario need not be restricted to 6 Km ISD. Release 17 (Rel-17) specifications is expected to support significantly higher ISD for rural uses cases both 3.3-3.6 GHz TDD band as well sub GHz FDD (e.g., 700 MHz) bands.

Increased coverage fundamentally stems from an improvement in link budgets offered by the physical layer. In the context of Rel-17 of 5G NR, such improvements may be obtained due to an increase in UE transmission power, use of additional antennas at gNB, or an inherent ability of the system to operate at lower SINR compared to Rel-15 and Rel-16 of 5G NR. Enhancements such as an increase in base station height, that reduces path-loss, are deployment-related improvements and are generally not related to 3GPP specifications.

Large cells result in low SNR or SINR. Therefore, the SI should target physical layer enhancements that support Voice over Internet Protocol (VoIP) and other enhanced Mobile Broadband (eMBB) services under much lower SINR conditions at cell edge than currently supported by 5G NR specifications. To support large cells, the link should support cell edge SINR that is [x] dB less than rel-16 of 5G NR. This implies that the system can support an additional [x] dB increase in MCL over rel-16 of 5G NR. Coverage enhancement SI should support higher MCL which directly results in higher ISD compared to existing IMT-2020 evaluations.

The specification should support uplink narrowband operation such as a single PRB allocation and sustained UE scheduling over multiple sub-frames under low SINR conditions. New mechanism to support [x] dB MCL increase, to maintain the required minimum target link data rate are required.

For large cells, with increasing distance, the link becomes dominated by the thermal noise. This is different from smaller cells where interference plays a significant role in determining cell capacity. Any technique that improves the link margin would result in a proportional increase in data rate independent of interference characteristics. DFT-S-OFDM waveform with pi/2 BPSK modulation offers low PAPR and allows maximum UE transmit power up to 26 dB. This feature should be considered for enhancing the cell coverage. Given that the system is noise limited, the increased UE power directly translates to an improvement in the link SINR.

Beam sweeping improves the SINR of a UE in both DL and UL as it allows radiated energy to be directed towards the UE. Evaluate potential link performance improvements by increasing the number of base station antennas ports/elements with finer beam sweeping.

To support [x] dB additional MCL, both DL and UL physical channels should support reliable channel estimation at low SINR conditions and low UE speeds or higher Doppler for high speed UEs. Evaluations should consider DMRS enhancements including those techniques that exploits existing PT-RS+DMRS to improve channel estimation at low SINR or higher Doppler, for example UEs moving at 500 Kmph. For AMR codec operating at 12.2 kbps, the payload generated is 256 bits (octet aligned), while EVS at 13.2 kbps generates 272-bit packet. Half rate, full rate, etc. may be supported depending on the voice quality.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for improving coverage of a cellular system is disclosed. The method comprising obtaining, by a base station, a transmission power capability of a UE. Also, the comprises determining, by the BS, a time-frequency opportunities allocated to the UE and determining a modulation and coding scheme (MCS) associated with the UE. Further, the method comprises indicating, by the BS, an increase in the instantaneous transmit power level to the UE based on the transmission power capability of the UE, the time-frequency opportunities and the associated MCS.

In another aspect of the present disclosure a method for improving coverage of a cellular system is disclosed. The method comprising obtaining by a user equipment (UE), the time-frequency opportunities allocated to the UE by a base station (BS). Also, the method comprises obtaining a modulation and coding scheme (MCS) associated to the UE. Thereafter, the method comprises determining, by the UE, an increase in the instantaneous transmit power level based on a transmission power capability of said UE, the time-frequency opportunities and the associated MCS.

In yet another aspect of the present disclosure a method for improving coverage of a cellular system is disclosed. The method comprising obtaining, by a communication system, a number of resource elements (REs) available for PUSCH data transmission in a time-frequency duration, said time-frequency duration comprises multiple transmission opportunities scheduled for a user equipment (UE). Also, the method comprises determining a transport block (TB) size that can be transmitted over the obtained REs and generating a TB consisting of data bits of length TB size, wherein the generated TB is appended with a cyclic redundancy check (CRC) for transmission.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows a block diagram of a base station (BS) for improving coverage of a cellular system, in accordance with an embodiment of the present disclosure;

FIG. 2 shows a block diagram of a user equipment (UE) for improving coverage of a cellular system, in accordance with an embodiment of the present disclosure:

FIG. 3 shows a block diagram of a communication system for improving coverage of a cellular system, in accordance with an embodiment of the present disclosure;

FIG. 4A shows the current assignment per slot;

FIG. 4B shows an updated TBS assignment across 4 slots, in accordance with an example embodiment of the present disclosure;

FIG. 5 shows a plot illustrating a Percentage of throughput as a function of the SNR and TBS scaling phenomenon, in accordance with an embodiment of the present disclosure;

FIG. 6 shows a flowchart illustrating for improving coverage of a cellular system, in accordance with some embodiments of the present disclosure;

FIG. 7 shows a flowchart illustrating for improving coverage of a cellular system, in accordance with some other embodiments of the present disclosure; and

FIG. 8 shows a flowchart illustrating for improving coverage of a cellular system, in accordance with another embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

Embodiments of the present disclosure provide methods and systems for improving coverage of a cellular network. For large cells, with increasing distance, the link becomes dominated by the thermal noise. This is different from smaller cells where interference plays a significant role in determining cell capacity. Any technique that improves the link margin would result in a proportional increase in data rate independent of interference characteristics. A Discrete Fourier Transform spread Orthogonal Frequency Division Multiplexing (DFT-S-OFDM) waveform with a pi/2 Binary Phase-shift keying (BPSK) modulation offers low p eak to average power ratio (PAPR) and allows maximum UE transmit power up to 29 dB for TDD configurations with low-duty cycle. This feature is considered for enhancing the cell coverage, provided that the system is noise limited, the increased UE power directly translates to an improvement in a link signal to interference plus noise ratio (SINR).

A user equipment (UE) transmission TX power is defined for Quadrature Phase Shift Keying (QPSK) with 23 or 26 dBm or 29 dBm or any power. The UE signals to a base station (BS) how much extra power it can transmit for pi/2 Binary Phase Shift Keying (BPSK) or for QPSK based on the allocations. The extra power could be 1 dB or 3 dB more depending on the type of power amplifier (PA) used. There would be a max power boost say 3 dB which can be signalled by the BS, which is also referred as gNB, to the user. There may be two messages in this signalling, one from UE to BS and other one from BS to UE. This type of signalling allows a power amplifier (PA) dimensioned for QPSK to boost an additional 1 dB power depending on the PA implementation. The appropriate power scaling can be applied based on the frame structure.

For example, with 50% duty cycle—26 dBm, for 25% duty cycle—29 dBm and for duty cycle between 25%-50% transmit power is in between 26-29 dBm. A PA designed for 26 dBm Quadrature Phase Shift Keying (QPSK) can transmit more than 26 dBm. Also, the design of the PA also allows the power boosting as per allocations of physical resource blocks (PRBs) in Frequency Division Duplex (FDD) or Time Division Duplex (TDD). As an example, allow power boosting in inner PRB allocations. The power boosting may be based on the frame structure and indicated by the BS to the UE. Considering multiple antennas are being used on the UE side for transmission (Tx), then 26 dBm for each PA may be configured. If not signalled explicitly by the BS to the UE, the UE may calculate the % of the UL transmission time and then calculate the power boosting factor as a function of the slot formats.

For example, if 25% UL slots are available, then 29 dBm can be used; if 30% UL slots is there then UE can use 27.77 decibel mill watts (dBm). Therefore, the signalling about the power boosting may be one of an implicit signalling and an explicit signalling from the BS to the UE. The power boosting instruction may be either implicit or explicit. Also, a Maximum power reduction (MPR) table may be used for the power boosting.

In an embodiment, there is a requirement to transmit at 32 dBm to achieve long range cell sites in 3.5 GHz TDD bands. The Tx power requirement is 32 dBm using a dual Tx implementation with a low duty cycle operation. This is with a single Tx chain, the Tx power requirement is 29 dBm. With a dual Tx implementation, using a PA dimensioned for 26 dBm, and with the MPR values defined for the inner RB allocation, when CP-OFDM QPSK waveform is used, the transmit power can reach a maximum of 24.5 dBm for a typical operational scenario. Using a dual Tx implementation, the overall power will be 27.5 dBm.

The system with power boosting and considering low PAPR of the waveform by employing pi/2 BPSK with a strong spectrum shaping, the PA may be operated near the saturation power level and the achievable power for a PA dimensioned for 26 dBm can be 29 dBm. This can be achieved without a significant cost increase w.r.t current 26 dBm PA reference but needs a new power class definition and an implementation based on this power class. Therefore, with the pi/2 BPSK DFT-s-OFDM waveform, using strong spectrum shaping, the MPR can be 0 dB which directly enhances the transmit power as shown below in the Table-I.

TABLE 1
Achievable power levels considering
MPR values (for inner RB allocations).

| Waveform | Achievable Power Levels |
|---|---|
| Pi/2 BPSK DFT-s-OFDM | 29 dBm |
| QPSK DFT-s-OFDM | 26 dBm |
| QPSK CP-OFDM | 24.5 dBm |

In an embodiment, defining PC1i as a power class supporting 32 dBm and PC1.5i supporting 29 dBm. This power classes shall be realized using pi/2-BPSK DFT-s-OFDM reference waveform with strong spectrum shaping. PC1i-Enable pi/2-BPSK DFT-s-OFDM reference waveform and achieve 32 dBm transmit power using dual Tx. PC1.5i-Enable pi/2-BPSK DFT-s-OFDM reference waveform and achieve 29 dBm transmit power using single Tx.

For pi/2 BPSK transmission, the same PA designed for QPSK may provide additional transmission (Tx) power as pi/2 BPSK can operate close to PCmax. Therefore, for duty cycle up to 25% or 50%, power boosting should be allowed.

One embodiment of the present disclosure is about power boosting, which may be time or frequency or modulation-based. Therefore, power boosting for either pi/2 BPSK or QPSK can be based on one of allocated subcarriers, inner-or-outer-PRB location, TDD frame structure type, and modulation type used i.e., pi/2 BPSK or QPSK or QAM. The reference max power can be based on QPSK or pi/2 BPSK. In an embodiment, the power boosting may be allowed for FDD also based on resource allocation, modulation and other parameters.

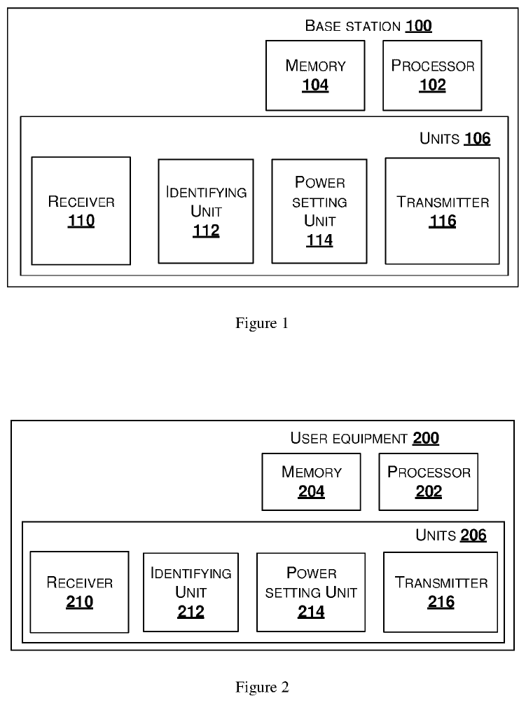

FIG. 1 shows a block diagram of a base station (BS) for improving coverage of a cellular network, in accordance with an embodiment of the present disclosure.

As shown in FIG. 1, the BS 100 comprises a processor 102, and memory 104 coupled with the processor 102. The BS 100 may be referred as any one of BS, gNode B or gNB or communication system. The processor 102 may be configured to perform one or more functions of the BS 100 for improving coverage of a cellular network. In one implementation, the BS 100 may comprise a plurality of antennas (not shown in the FIG. 1) and blocks or units 106, also referred as modules for performing various operations in accordance with the embodiments of the present disclosure.

The blocks 106 includes a receiver 110, an identifying unit 112, a power setting unit 114 and a transmitter 116. In an embodiment, the receiver 110 may include a plurality of receivers, for simplicity it is referred as the receive. In an embodiment, the transmitter 116 may include a plurality of transmitters, for simplicity it is referred as the transmitter.

For improving the coverage of a cellular network, the receiver 110 configured in the BS 100 obtains a transmission power capability of a user equipment (UE). It is well understood that the receiver receives information or data, which may be referred as an input from the UE. From the input the receive obtains the transmission power capability of a user equipment (UE).

The identifying unit 112 determines a time-frequency opportunities allocated to the UE. The time-frequency opportunities comprise one of contiguous and dis-contiguous transmission opportunities in time. Also, the identifying unit 112 determines a modulation and coding scheme (MCS) associated with the UE from the received input. The modulation scheme is one of a binary phase shift keying (BPSK), a pi/2 BPSK, a Quadrature Phase Shift Keying (QPSK) and a quadrature amplitude modulation (QAM). The transmission power capability is a function of the MCS.

The power setting unit 114 identifies an increase in the instantaneous transmit power level to the UE based on the transmission power capability of the UE, the time-frequency opportunities and the associated MCS. The identified increase in the instantaneous transmit power level is indicated to the UE by using the transmitting the same using the transmitter 116.

FIG. 2 shows a block diagram of a user equipment (UE) for improving coverage of a cellular network, in accordance with an embodiment of the present disclosure.

As shown in FIG. 2, the UE 200 comprises a processor 202, and memory 204 coupled with the processor 202. The UE 200 may be referred as one of mobile system or mobile device or a communication system or a user. The processor 102 may be configured to perform one or more functions of the UE 200 for improving coverage of a cellular network. In one implementation, the UE 200 may comprise a plurality of antennas (not shown in the FIG. 2) and blocks or units 206, also referred as modules for performing various operations in accordance with the embodiments of the present disclosure.

The blocks 206 includes a receiver 210, an identifying unit 212, a power setting unit 214 and a transmitter 216. In an embodiment, the receiver 210 may include a plurality of receivers, for simplicity it is referred as the receive. In an embodiment, the transmitter 216 may include a plurality of transmitters, for simplicity it is referred as the transmitter.

For improving the coverage of a cellular network, the receiver 210 configured in the UE 200 receives information or data from the BS 100. The identifying unit 212 configured in the UE 200 determines or obtains the time-frequency opportunities allocated to the UE by a base station (BS).

The identifying unit 212 determines a time-frequency opportunities allocated to the UE. The time-frequency opportunities comprise one of contiguous and dis-contiguous transmission opportunities in time. Also, the identifying unit 212 obtains a modulation and coding scheme (MCS) associated with the UE. The modulation scheme is one of a binary phase shift keying (BPSK), a pi/2 BPSK, a Quadrature Phase Shift Keying (QPSK) and a quadrature amplitude modulation (QAM). The transmission power capability is a function of the MCS.

The power setting unit 214, configured in the UE 200, determines an increase in the instantaneous transmit power level based on a transmission power capability of said UE, the time-frequency opportunities and the associated MCS. The determined increase in the instantaneous transmit power level may be indicated to the BS by using the transmission via using the transmitter 216.

One embodiment of the present disclosure is about power boosting for VOIP in FDD systems. In FDD. since for VOIP systems, the transmission may not occupy all UL slots, the transmission power can be boosted based on the modulation being used such as pi/2 BPSK or QPSK and the PA being used and the traffic payload (e.g. codec rate being supported). In all power boosting cases, the power boosting will be based on the UE specific signalling or common signalling based on the UEs, the UE transmission characteristics, UE PA being used, how much the UE can boost, among others. This signalling may be informed to the UE or the UE may implicitly boost the signal while adhering to the power limits in those UL slots where VOIP transmission actually takes place. The UE based PCMax signalling and indication is also supported via DCI or RRC or UCI or other means. The power control mechanisms will be appropriately handled based on these PCMax values. The power control can be based on boosted power, or normal PCMax. Power boosting can also be waveform specific and indicated to a UE whether or not to support boosting based on CP-OFDM waveform vs DFT-s-OFDM waveform. Power boosting can also be a function of whether the UE performs spectrum shaping or not which further reduces the PAPR of the transmission and allows the UE to transmit at peak power levels.

In another embodiment, the frequency domain allocation also can be used for deciding the same boosting along with MPR, AMPR values. The MPR values can be set based on the TDD/FDD frame structures, RBs associated with the UE, allowing bandwidth expansion to the UE to reduce the PAPR in a non-transparent fashion, wherein these extra PRBs may be explicitly indicated to the UE as guard RBs for bandwidth expansion among others. This could also include an indication for the UE whether or not it performs spectrum shaping as the receiver may have to take this into account.

In one embodiment, pre-DFT multiplexing of data and DMRS may be used. The density of the DMRS may be configured in a UE specific manner, either in a dynamic fashion or based on a configuration table whose indices will be given to each user. The DMRS density can be in terms of chunks of DMRS with multiple chunks separated by few samples and each chunk having some DMRS samples. This number of chunks and samples per chunk may be dynamically configurable to support UEs with varying speeds, varying channel conditions, cell edge vs cell centre among others. Having self-contained DMRS-data transmission in 1 OFDM symbol will be beneficial for the coverage purposes. These DMRS could be ZC, pi/2 BPSK with or without shaping, and data could be QPSK or pi/2 BPSK with or without shaping among others. There could be power boosting on DMRS samples and/or data samples among others. All of this may be supported via UE specific or UE common signalling such as a group common signalling for all cell-edge UEs. For instance, this could be used in satellite (non-terrestrial network)-based transmissions also wherein all users within farther beams can use this kind of transmission. All these methods or the embodiments may also be used for non-terrestrial network-based transmission.

One embodiment of the present disclosure is slot repetition and power boosting. One PUSCH transmission instance is not allowed to cross the slot boundary for PUSCH. Therefore, to avoid transmitting a long PUSCH across slot boundary, the UE may transmit small PUSCHs in several repetitions scheduled by an UL grant or RRC in the consecutive available slots. This method is called PUSCH repetition Type A. A UE may be configured to transmit a number of repetitions across consecutive slots without feedback from the BS. In Type-A, every slot used in repetition assumes same allocation in time and frequency.

Another embodiment of the present disclosure is Type-B, in which a restriction of consecutive slots is removed by introducing notion of nominal slots. Here even when D slots come into the frame structure, the UE takes care of them and waits for next available U symbols/slots and sends repetitions on those symbols/slots. the time domain resource is indicated by the BS for the first nominal repetition while the resources for the remaining repetitions are derived based at least on the resources for the first repetition and UL/DL direction of symbols.

The repetitions alone cannot help to achieve the necessary coverage. The transmit power boosting can significantly enhance the coverage of the system as the UE transmit power enhances link budget. However, due to regulatory considerations the UE cannot send high power all the time, it needs to follow a duty cycle. For example, a UE needs to maintain 23 dBm as the average power over a time period. Then within this time period, it can send 26 dBm at 50% duty cycle, 29 dBm at 25% duty cycle, and 32 dBm at 12.5% duty cycle and so on.

In an embodiment, the UE is with a combination of power boosting and repetitions. When a UE is configured for repetitions as well as power boosting, then one of the sub-frames or slots or symbols over which the UE sends transmissions have to be handled properly considering this duty cycle restriction as the UE cannot send in all those repetition time instants if it has to satisfy the power constrains defined over a time period. There are various methods, in method-1 and method-2, which are for the cases i.) when the UE sends 1 TB and ii.) repetitions of this TB across different repetitions as shown in Type-A and Type-B frameworks. Such as rv0 in 1st transmissions, rv1 in 2^{nd} transmission and so on. In another method-3, is of sending transport block across multiple slots.

The time over which the power must be maintained to 23 dBm must be taken into account while assigning the repetitions. For instance, the below designs will have to be correctly accounted for if the time of power measurement is 10 ms or 20 ms etc. and then appropriate subframes or slots may be assigned for repetitions.

One embodiment of the present disclosure is method-1. In method-1, all UE's are configured with power boosting and repetition, an additional signaling is exchanged between a UE and a BS indicating the duty cycle, or introducing Typ-A1 or Tpe-B1 repetitions that deliberately introduce blanking (or no-transmit) time slots deliberately. As an example, consider the UE is configured with 16 repetitions and 25% duty cycle, then the UE instead of sending in 16 consecutive UL slots, it will send 1 in 4 UL slots. Since the UE is in power boost mode, the same performance of 16 repetitions scenario can be achieved using 4 repetitions with blanking. Then 4 repetitions with power boosting would take 16 time slots. And this starts with the 1^{st} slot of every 4 UL slots as per the TDD frame structure. The blanking time slots would be free up resources for other UE to be scheduled. That results in a higher overall capacity/data rate increase for the network. When power boost factor is not an integer value, the number of blanks introduced are handled properly, by either rounding off to the smallest nearest number of slots.

One embodiment of the present disclosure is method-2. In method-2, Bitmap for users—for 2 UEs, which will do repetitions and power boosting, the blanking frames, slots, subframes, symbols aka the frames where the UE won't send in order to do power boosting in other frames, slots and subframes, may be interleaved. A bitmap of 1000 indicates UE1 will send data with power boosting in 1^{st} slot/symbol/subframe/frame and for the UE2 a bitmap of 0100 will be sent which indicates that it will send in the 2^{nd} set of slot/symbol/subframe/frame which won't overlap with the UE1.

One embodiment of the present disclosure is method-3. In method-3, a restriction on the TDD frame structure may be imposed when the power boosting factor is used. For instance, for 26 dBm only frame structures with 40% or less duty cycle can be used. For 29 dBm power boosting only frame structures with 20% or less duty cycle can be used. For 32 dBm power boosting only frame structures with 10% or less duty cycle can be used. When UEs with both 29 dBm and 32 dBm will be multiplexed, then a UE pairing algorithm to pack users in time domain among the time domain UL slots and S slots will be used.

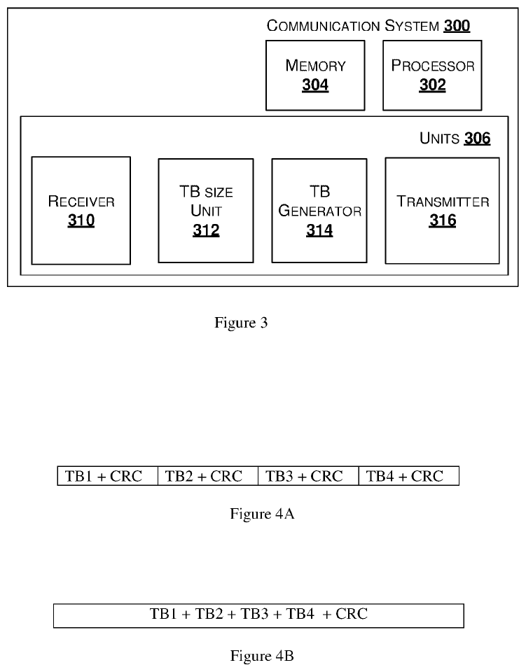

One embodiment of the present disclosure is transport block size (TBS). The TBS values are limited to be 24 bits based on the allocation and the MCS used, in technical specifications. For this transmission, when a CRC of 16 bits is attached, the overhead is almost 70%. When the TBS+CRC is rate matched to a small allocation size of 1 PRB or 4 PRBs, i.e. typically required for higher coverage to ensure higher power spectral density, the rate matching does not ensure to achieve the required code rates at low SNR. The code rate can be used for one of low-density parity-check (LDPC), turbo, polar, convolution or any other channel encoder. Additional to CRC overhead, in the case of conventional eMBB systems, a TB spans a N_{symb} number of symbols with N_{prb} number of PRBs. This is performed by the communication system as shown in FIG. 3.

FIG. 3 shows a block diagram of a communication system for improving coverage of a cellular system, in accordance with an embodiment of the present disclosure.

As shown in FIG. 3, the communication system 300 comprises a processor 302, and memory 304 coupled with the processor 302. In an embodiment the communication system is a base station (BS) or gnode B or gNB. In an embodiment the communication system is a user equipment (UE) or mobile device or mobile station. The processor 302 may be configured to perform one or more functions of the communication system 300 for improving coverage of a cellular network. In one implementation, the communication system 300 may comprise a plurality of antennas (not shown in the FIG. 3) and blocks or units 306, also referred as modules for performing various operations in accordance with the embodiments of the present disclosure.

The blocks 306 includes a receiver 310, a transport block (TB) size unit 312, a transport block (TB) generator unit 314 and a transmitter 316. In an embodiment, the receiver 310 may include a plurality of receivers, for simplicity it is referred as the receive. In an embodiment, the transmitter 316 may include a plurality of transmitters, for simplicity it is referred as the transmitter.

For improving the coverage of a cellular network, the receiver 310 configured in the communication system 300 obtains a number of resource elements (REs) available for PUSCH data transmission in a time-frequency duration, said time-frequency duration comprises multiple transmission opportunities scheduled for a user equipment (UE). The time-frequency duration includes a frequency allocation in terms of one of subcarriers, resource block (RB), sub-bands, and resource block groups (RBGs). Also, the time-frequency duration is indicated to the UE. The number of resource elements (REs) account for a number of reference signals (RS) in the time-frequency duration.

The RS is used across the transmission opportunities based on the UE capability. The UE capability indicates the ability to maintain transmission parameters over the said transmission opportunities. The transmission parameters include a phase coherence of a transmitter configured in the communication system. The location of the RS for the multiple transmission opportunities is indicated to the UE, by the BS.

The TB size unit 312 determines a TB size that can be transmitted over the obtained REs. The TB generator unit 314 generates a TB consisting of data bits of length TB size. The determined TB size or generated TB is transmitted with different redundancy version (RV) in different transmission opportunities. Also, the generated TB is appended with a cyclic redundancy check (CRC) for transmission. The generated TB is encoded using a channel encoder for transmission to the UE using the transmitter 316.

In an embodiment, a modulation and coding scheme (MCS) is used for the transmission for the TB. The MCS is selected from a MCS table for achieving optimized signal to noise ratio (SNR) conditions for an extreme coverage. The MCS table is obtained for a predefined SNR and a MCS is selected to achieve a predefined block error rate. The TB size is determined using the obtained number of REs and the MCS.

The number of REs are determined using at least one of all OFDM symbols in uplink slots, one or more symbols in uplink slots, and one or more uplink symbols in special slots. In an embodiment, the number of REs in each of the transmission opportunities is same in all the multiple transmission opportunities and a scaling factor is used to determine the TB size. The scaling factor is the number of transmission opportunities given to the UE. Also, the scaling factor is indicated to the UE by the BS in one of a dynamic and a semi-static manner.

Further, the UE obtains the transmission opportunities according to a signaling that indicates considering special slots or without considering the special slots to obtain the number of REs for transmission.

The time allocation for the UE is indicated using one of:
a. starting transmission opportunity location and ending transmission opportunity location; and
b. starting transmission opportunity location and length of the total opportunity indicated using at least one of number of symbols and number of slots.

The starting transmission opportunity location is a symbol in one of UL slot or special slot.

In an embodiment, the UE does not transmit in a transmission opportunity if it is determined that the said transmission opportunity collides with a higher priority transmission.

In an embodiment, the number of symbols (N_{symb}) for a user is obtained by the Time Domain Resource Allocation (TDRA) given to the user. TDRA is indicated to the user using DCI. The TDRA for the UE can have the following options:
a. PUSCH Repetition Type A, i.e., the number of symbols allocated to the user in every slot is same.
b. PUSCH Repetition Type B, i.e., the number of symbols allocated to the user in every slot is different.

Similarly, the number of Physical Resource Blocks (N_{prb}) allocated to a UE shall be determined using the resource allocation field in the detected PDCCH DCI The number of Physical Resource Blocks (N_{prb}) allocated to a UE is same per symbol and is same across all the slots allocated to the UE. It can also be allowed that the number of PRBs per slot is different for all slots involved in this. However, new indications of the resource block allocation per slot or some common understanding between UE and gNB is mandatory, or the UE may assume a fixed indication for all U slots and fixed indication for all S slots with U symbols. This can be send to UE via gNB via DCI or RRC or MAC signaling.

A higher N_{prb} value results in an increase of effective noise power at the receiver, which eventually results in lower MIL and MPL values which directly reduce the UE coverage. Hence, MIL (maximum isotropic loss) and MPL (maximum path loss) values can be increased by decreasing the number of PRBs which amounts to narrow-banding operation. However, to maintain the data rates such as to achieve the target data rate, when the frequency domain resources are reduced, the time domain resources may be increased i.e., by aggregating the slots. Therefore, TBS scaling approach is considered wherein the TBS is calculated such that the UE may be scheduled to transmit a larger TBS using the RBs across multiple slots. For this entire TBS, there would be one CRC and would reduce the overhead. This would help to achieve higher data rates using less frequency allocation. Also, maintaining the code rate in this approach so that MCL (maximum coupling loss) could be improved. TB scaling approach can also be referred to as slot aggregation method.

The TBS in 5G NR may be calculated as min (156, N_{RE})*Qm*v*R*N_{prb}; and if this value is less than 3824, a table-6 is used. The table-6 is shown in Annex-1. Considering TBS_scaleK as a parameter, which defines the number of slots for which a single TB has to be generated. This parameter can be signalled semi-statically to a coverage limited UE as identified by the base station via RRC signalling or via DCI signalling through a new DCI format dedicated for coverage limited UEs with small DCI size which can be decoded even under extreme coverage conditions. The TBS_scaleK indicates that the TBS calculation should be performed over N_{prb} as in the existing scenario, but the calculation can be further scaled as follows:

For N_{prb}, use the formulas in Annex to calculate the TBS_annex size, as in the existing scenarios. The frequency domain resources are indicated to the UE for 1 slot via the DCI format when the existing DCI format is used and RRC signaling is used to indicate TBS_scaleK. When a new DCI format is introduced to indicate TBS_scaleK, then also the gNB may continue to indicate the frequency domain resources for 1 slot only.

The final Transport block to be transmitted by the UE is be calculated using the following approaches
a. The resulting TBS_annex from annex is scaled as TBS_annex*TBS_scaleK to find the effective TB_final size.
b. Calculate N′_{RE} as defined in Annex

$$\begin{matrix} & {N}_{RE} = min ( 156 , {N}_{RE}^{′} ) * {N}_{prb} * {TBS}_{scaleK} \\ & {N}_{info} = {N}_{R E} * R * Q m * v \\ c . & {N}_{RE}^{′} = ( {N}_{s c}^{R B} {N}_{s y m b}^{s h} - {N}_{D M R S}^{P R B} - {N}_{o h}^{P R B} ) \\ & {N}_{R E} = min ( 156 * TBS\_scaleK , {N}_{RE}^{′} ) * {N}_{p r b} \\ & {N}_{info} = {N}_{R E} * R * Q m * v \\ d . & {N}_{RE}^{′} = ( {N}_{s c}^{R B} {N}_{s y m b}^{s h} - {N}_{D M R S}^{P R B} - {N}_{o h}^{P R B} ) \\ & {N}_{R E} = min ( ( {N}_{symb}^{sh} - 1 ) * 12 * TBS\_scaleK , {N}_{RE}^{′} ) * {N}_{p r b} \\ & {N}_{info} = {N}_{R E} * R * Q m * v\end{matrix}$$

e. Introduce new TBS entries into the Table-6.

For example, the entries may be 24, 32, and the like. To account for more combinations, some entries are included in the table-6 to increase the TBS sizes that will be allowed to be used, as shown in FIGS. 4A and 4B. FIG. 4A shows the current assignment per slot. FIG. 4B shows an updated TBS assignment across 4 slots, in accordance with an example embodiment of the present disclosure.
f. Another method is where, consider REs in all slots plus symbols ahead of time and then calculate TB size over all these REs jointly. For this method, all possible Ul symbols in S slots and UL slots may be considered.

Attach a single CRC to TBS_{New} and transmit over TBS_scaleK slots over the same number of frequency resources indicated in step-1. The CRC removal at the receiver is performed after the reception of TBS_scaleK slots.

The number TBS_scaleK can be indicated via DCI/RRC/MAC signaling. The existing repetition factor parameter can be enhanced to support larger number of repetitions. The slots that can be aggregated for this transmission can be physically consecutive or non-consecutive. In logical terms when Type-B repetition is used, then these slots can be logically consecutive.

For a cell edge UE, typically lower MCS values will be used. In order to ensure that the legacy maximum supported TB size is not exceeded, a limit on N_prb, or N_slots is required. In any wireless communication system, narrow banding helps in improving cell coverage. Narrow banding helps in the link budget gain, which comes in the form of reduction in the receiver noise figure in the link budget analysis. A decrease in the frequency domain allocation N_{prb} by a factor of ‘P’ results in a 10*log10(N_{prb}/P) dB gain in the effective noise figure. Having an unlimited range for the slots allocated to a UE, the size of the TB will be very large due to the scaling as shown earlier, as well as, there is a chance of having the allocated symbols with the either Downlink symbols or uplink symbols scheduled for transmission other than PUSCH. To avoid this, the maximum number of slots allocated to a UE for above mentioned TBS calculation can be indicated to the UE. In addition, a restriction on the number of PRBs, etc. may also be signalled. A restriction could be based on the number of code blocks such as limiting to 8448 which is the max Tb size without any segmentation.

Nₒₕ^{PRB} is the overhead in the resources allocated to the user in one PRB. Nₒₕ^{PRB} can have the values according to the following options:
a. Nₒₕ^{PRB} can be same across all the symbols in the slots allocated to the UE.
b. Nₒₕ^{PRB} is specific to the symbols or the slots allocated to the UE and is calculated depending on x Overhead and the number of symbols or slots allocated to the UE.

Additionally, the slots allocated the user can be either consecutive or non-consecutive in both TDD and FDD format. When complete UL slots are allocated to the UE for TB transmission, like Repetition type A kind of TDRA, all the options mentioned previously in TB calculation can be used for transport block calculation, while for Nₒₕ^{PRB} can be obtained from option 1 defined above. However, when the UE is allocated with specific symbols in complete UL slots along with the symbols from the special slots in TDD format, option 2 from above can be utilized. This can be estimated using all REs determined across the slots over which the aggregated TB transmission is performed. Or using all REs determined across the symbols carrying one instance of the transport block where repetition is supported.

When the UE is allocated with certain number of symbols to transmit the user data, like a Repetition Type B kind of TDRA, to calculate the transport block size options b, c, e, and f can be used. To obtain the Nₒₕ^{PRB} option 2 is preferred. The number of symbols ‘L’ allocated to the user under Repetition Type B is up to 28 symbols. In this case, the SLIV table indicating the time allocation and symbol allocation can be modified as follows.

TABLE 5.1.2.1-1
Valid S and L combinations

| PDSCH | Normal cyclic prefix | | |
|---|---|---|---|
| mapping type | S | L | S + L |
| Type A | {0, 1, 2, 3} | {3, . . . , 14} | {3, . . . , Lmax} |
| | (Note 1) | | |
| Type B | {0, . . . , 12} | {2, . . . , 13} | {2, . . . , Lmax} |

The S+L values can be as long as 2 slots, 3 slots or 4 slots. Lmax can be a configurable value indicated from gNB to the UE. For example, this can be 28 for 2 slots, 42 for 3 slots etc. The starting symbol can be anywhere in a given slot and from there the length of the transmission across slots can be calculated. On top of this there will be multiple number of such combinations that will be considered for a joint transmission. Basically, using SLIV we can define a smallest unit of transmission and then we can expand this over multiple time instants where this smallest unit is used throughout over “K” times where K is the same as the TBS_scaleK factor.

There are multiple options to handle the resources in S slot.
a) Skip S slot for aggregated TB transmission
b) Consider S slot inside the S+L calculation in SLIV
c) If SLIV calculation fits the number of resources in S slot UL symbols, then S slot can be used, else it is skipped.

The complete transmission time of the slots over which the TB processing occurs is termed as TBoMS occasion. When the number of slots or the number of symbols over which TB processing is performed are very large, the data transmission may get interfered with either other uplink transmission (like PUCCH, SRS etc.,) or with other user transmissions like URLLC. In this scenario, the user can transmit the data when UE has enough number of symbols to transmit the data otherwise, UE transmits the data over symbols or slots which does not have URLLC transmission or the PUCCH or other uplink transmission. The UE can stop these transmissions and the gNB may receive an indication/understand that the UE has stopped this transmission, wherein the stopped symbols LLRs won't be considered in decoder processing. The other following mechanisms may also be considered for collision handling:
UCI can be multiplexed inside the aggregated TB when PUCCH transmission overlaps in at least one slot.
When PUCCH overlaps with aggregated TB in time in at least one slot, the whole aggregated TB transmissions is dropped and PUCCH is transmitted in the overlapped duration.

The repetitions of TBoMS may also be supported within the same framework. After 1 TB is sent across multiple slots, the ensuing slots will be used for sending repetitions of the same TB. The rv index to be sent can be rv0 1 2 3 and cycled as per a priori agreed rv cycling format between gNB and UE or can be indicated dynamically, or it can be a function of the slot number/repetition number etc. The same mechanism can be extended for the case of retransmission of this first aggregated transport block transmission.

A UE may be indicated to dynamically, via DCI, switch between aggregated TB transmissions versus traditional single slot transmission. This can also be indicated via RRC in semi-static manner if the UE is deemed to be a static UE.

The BLER performance with TB processing over multiple slots is similar to that of without such slot aggregation. However, the link budget gain comes in the form of reduction in the receiver noise figure in the link budget analysis. A decrease in the frequency domain allocation N_{prb} by a factor of 4 results in a 6 dB gain in the effective noise figure. The number of slots aggregated can depend on the required data rates. Based on the frame structure informed to the UE by the gNB, the UE may calculate the number of consecutive full UL slots for the above TB calculations. In the case of special slots, the TB calculation will change based on the number of UL resources available in the special slots.

A UE may indicate to the gNB that it can support slot aggregation via a UE feature parameter. Thereafter, the gNB signals a TBS_scaleK factor to the UE which indicates the number of slots over which the UE must calculate the effective transport block size using the frequency domain resources indicated via the DCI. The frequency domain allocation is assumed to be the same across TBS_scaleK slots, including special slots. The number of slots to aggregate can vary between 1,2,4, and 8. If not indicated, the UE only assumes 1 slot processing.

The signalling can be via RRC or DCI formats. When DCI is indicated, the UE uses the same DCI instruction until the TBS_scaleK slots. When RRC is used, the UE uses it until the next RRC message is received to change the aggregation factor.

When only full UL slots are considered for the slot aggregation, the instruction for time-frequency assignment received via DCI sent for 1 slot can be scaled with the total number of UL slots indicated to be aggregated. When S slots are considered following situations arise:
The instruction about time duration should be handled for all the upcoming slots i.e., the number of symbols to be used shall be maintained constant over all the transmissions of the TBS_scaleK slots. In this case, when the time duration indicates a number of UL symbols greater than the number of symbols in S slots, then S slots will be skipped.
If the number of UL symbols allocation indicated in DCI is less than or equal to number of UL symbols in S slot, then the S slot will also be used for aggregation. Or the UE may be either explicitly or implicitly indicated to use or to not use the S slot during the slot aggregation.
Another method is one where irrespective of the instruction from the BS, the UE will account for all U slots as well as S slots in the upcoming slots and calculate an effective TBS as follows

$$TBS\_eff = TB * N\_full \_UL \_slots + alpha * TB * N\_S \_slots$$

Where, N_full_UL_slots are the number of U slots and N_S_slots are the number of S slots available, and TB is the size of the TB that fits in 1 UL slot as instructed in DCI, alpha is the fraction of TB that fits in S slot as compared to full UL slot calculated as:
Alpha=N_UL_symbols_in_S_slot/N_UL_symbols_allocated_in_UL_slot,
   i.e., the ratio of number of UL symbols in S slot to the number of UL symbols allotted to the user in UL slot.
Another approach is that the gNB signals separately the number of symbols to be used in UL slot and the number of symbols to be used in S slot in cases of such slot aggregation
The gNB can signal the time frequency allocation for S slot as well as UL slot when slot aggregation will be used. Similar concept can be used for UL repetitions as well.
The slot aggregation instruction may be followed by the UE from a particular time instant as indicated by the gNB or the closest UL slot after the instruction is received or the closest S slot after the instruction is received.
A new DCI format may be introduced to signal both the UL and S slot allocations.
The UE may be instructed to use DMRS data multiplexing in S slot or not separately of the UL slot. The DMRS assignment may be explicitly indicated to the S slot when such slot aggregation is performed.
The UE may be instructed/or may assume to use the same waveform in both UL and S slots. The UE may be instructed to use different waveforms in UL and S slots.
The DMRS may be aggregated for channel estimation across consecutive UL slots when such slot aggregation is used. This can be signalled to the UE via DCI or RRC. In such case, UE may have to maintain the phase coherency across all slots aggregated.

The similar procedures can be used when repetitions are to be allowed either type-A or Type-B. The S and UL slots may be considered together for the repetition transmission. The rate matching in S slot can be as per S slot allocation. The RV index to be used can be cycled wither jointly with UL and S slots or separately for UL and S slots. This can be instructed to the UE separately. The number of repetitions to be performed are informed to the UE via DCI or RRC signalling. The retransmissions are done only after the UE finished the repetitions instructed by the BS upon a ACK/NACK reception. The gNB calculates ACK/NACK only after the prescribed number of repetitions are done by the UE.

The repetition may be used for DL PDSCH as well in addition to UL PUSCH.

The redundancy version indices may be further split beyond 0, 2, 3, 1. To create 00,01,10,11,20,21,30,31 etc. These finer versions may be sent for repetitions or retx over smaller bandwidths when required. The type of RVs being used may be indicated to the user via an RRC message, oldRVmethod or newRVmethod. The Downlink Control Information (DCI) formats will accommodate the signalling of old and new RV indices.

Transport block (TB) repetitions within a slot, and define half slot allocation as a unit. Frequency hopping across repetitions within a slot may be considered. The number of repetitions inside a slot can be configured based on the number of symbols allotted to each allocation. PUSCH mapping Type-B may be considered here along with repetition inside the slot.

TB repetitions across slots in FDD as well as TDD. Repetition type-A and B both can be used.

Indicate usage of full-rate/half-rate or quarter-rate voice packets for VOIP services. Defines the UE to use the appropriate codec at Tx side and the BS to use the correct codec at the receiver side. In an embodiment, the BS should adaptively allocate, the modulation type (including pi/2 BPSK and QPSK), code rate including the repetition method, the number of allocated subcarriers (or PRBs), and the codec rate and type. The system should be able to dynamically allocate the aforementioned parameters to schedule a cell edge UE having low SNR or SNR.

Some baseline results show a gain obtained by using the slot aggregation factor of 2 and 4 for enhanced Mobile Broadband (eMBB) use case, this is using the TBS scaling method/technique. Table-1 shows SINR gain due to TBS scaling/slot_aggregation:

TABLE 1

| | | Base code rate | Slot agg fac = 2 | | Slot agg fac = 4 | |
|---|---|---|---|---|---|---|
| MCS | TBS | (TBS + CRC)/(N_RE*Q_M) | Rate | Gain(dB) | Rate | Gain(dB) |
| 0 | 32 | 0.1667 | 0.1389 | 0.791 | 0.125 | 1.25 |
| 1 | 40 | 0.1944 | 0.1667 | 0.668 | 0.1527 | 1 |
| 2 | 48 | 0.2222 | 0.1944 | 0.58 | 0.1805 | 0.9 |
| 3 | 64 | 0.2778 | 0.25 | 0.458 | 0.2361 | 0.7 |
| 4 | 80 | 0.3333 | 0.3055 | 0.378 | 0.2917 | 0.579 |

$$\begin{matrix}Rate = \frac{{slot\_agg}_{fac} * TBS + CRC}{{N}_{R E} * {Q}_{m}} \\ Gain = 10 * {log}_{10} ( \frac{Base code rate}{Rate} )\end{matrix}$$

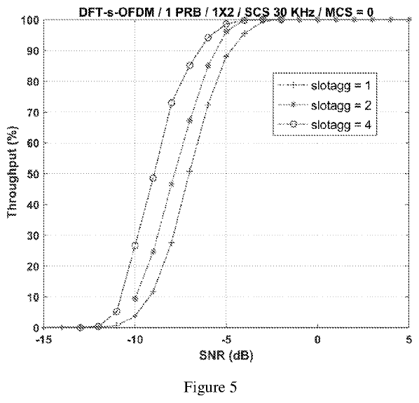

FIG. 5 shows a plot illustrating a Percentage of throughput as a function of the SNR and TBS scaling (slot_aggregation) phenomenon, in accordance with an embodiment.

One embodiment of the present disclosure is based on reference signal (RS). To support improved MCL values, both DL and UL physical channels should support reliable channel estimation at low SINR conditions and low UE speeds or higher Doppler for high speed UEs. Also, the following evaluations should consider DMRS enhancements including those techniques that exploits existing PT-RS+DMRS to improve channel estimation at low SINR or higher Doppler, for example UEs moving at 500 Kmph.
a. A UE may be configured with higher density DMRS to allow for better channel estimates.
b. A DMRS density may be increased.
c. The channel estimation may be based on DMRS across multiple UL slots. Depending on the frame structure, The UE may be indicated to not change its antenna, power, etc. over these many slots to allow for channel interpolation/averaging. This is required to ensure phase coherence across time. For this the UE may be indicated a parameter “phase_coh_time” which indicates that the UE must maintain its transmission parameters constant across “phase_coh_time”. This parameter may be indicated in terms of symbols, slots or sub-frames or frames to the UE by the BS via RRC/MAC/DCI messages.
d. The DMRS may be accompanied along with frequency hops taken by the user. Dynamic DMRS positions may be indicated for each user according to its allocation. This DMRS location may be indicated via DCI along with resource allocation to the user.
e. DMRS channel estimation across hops, across PRBs, across slots etc. to be allowed. This needs indication to the user to keep its transmission parameters constant.
f. Frequency hopping across slots, subframes, frames, symbols etc. should be allowed.

All features in this invention may also be used for PDSCH such TB scaling, repetition, DMRS enhancements etc. as required.

The following base units/methods or designs may be defined for the user for resource allocation.

In another method-4 or design, Sub-PRB allocation such as NB-IoT, 1 to 12 tones any number can be allocated. There can be sub-carrier hopping across OFDM symbols or slots or subframes or frames. 6-tones allocation may be used in conjunction with DMRS bundling across time (to allow phase coherent channel estimation). There can be 2-fold power boosting ->there can be frequency specific power boosting as per allocation and then modulation-based power boosting which can be activated. Furthermore, TDD slot structure power boosting can be invoked. Each of these can be indicated to the UE via RRC signaling from the BS or implicitly done by the UE.

In the four methods, a plurality of inputs data symbols comprising of a plurality of channel coded pi/2 BPSK DFT-S-OFDM symbols covered with a first cover code assigned for transmission over a first time-frequency resources comprising of at least one OFDM symbol and at least one frequency unit.

The pi/2 BPSK DFT-S-OFDM BPSK with first cover code comprises of channel coded BPSK modulation data has 90-degree constellation rotation between successive modulation elements, precoding one of before DFT or after DFT, one of localized and distributed subcarrier mapping, IFFT to generate a first plurality of signals mapped to a first time-frequency resources comprising of at least one OFDM symbol and at least one frequency unit.

Also, the method comprises multiplexing of plurality of inputs data symbols comprising of a plurality of channel coded pi/2 BPSK DFT-S-OFDM symbols covered with a first cover code with a plurality of first RS symbols to generate a first transmission unit.

The plurality of inputs data symbols comprising of a plurality of channel coded pi/2 BPSK DFT-S-OFDM symbols covered with a second cover code assigned for transmission over a second time-frequency resources comprising of at least one OFDM symbol and at least one frequency unit.

Multiplexing of plurality of inputs data symbols comprising of a plurality of channel coded pi/2 BPSK DFT-S-OFDM symbols covered with a second cover code with a plurality of second RS symbols to generate a second transmission unit. Further, transmission of first and second transmission unit will be performed as indicated by the BS.

The procedure or method includes first cover code comprises of multiplication of each of pi/2 BPSK DFT-S-OFDM symbols with an element of a first cover code. Also, the method includes first cover code comprises of spreading of channel coded BPSK modulation data of each of pi/2 BPSK DFT-S-OFDM symbols with a portion of a long first spreading code.

Also, the procedure includes second cover code comprises of multiplication of each of pi/2 BPSK DFT-S-OFDM symbols with an element of a second cover code. The procedure including second cover code comprises of spreading of channel coded BPSK modulation data of each of pi/2 BPSK DFT-S-OFDM symbols with a portion of a long second spreading code.

The first time-frequency resource is a PRB and second first time-frequency resource size in time and frequency is equal to the first time-frequency resource. The subcarriers of second first time-frequency resource are equal to the first time-frequency resource and OFDM symbols of second time-frequency resource are contiguous to first time-frequency resource. The subcarriers of second first time-frequency resource are equal to the first time-frequency resource and OFDM symbols of second time-frequency resource are non-contiguous to first time-frequency resource.

The OFDM symbols of second first time-frequency resource is equal to first time-frequency resource and subcarriers of second first time-frequency resource is contiguous to first time-frequency resource. The OFDM symbols of second first time-frequency resource is equal to first time-frequency resource and subcarriers of second first time-frequency resource is non-contiguous to first time-frequency resource. The second first time-frequency resource size in time and frequency is unequal to the first time-frequency resource.

In an embodiment, a methodology is used to employ CDMA-type spreading techniques, multiplex multiple users, and this spreading interval can be across subcarriers, PRBs, slots, subframes, frames, and etc. A modified configuration table may be defined which includes the combinations of the base units, spreading intervals, etc. and transmits only a configuration index of this table to the user.

Another embodiment is related to Voice over Internet Protocol (VOIP). By performing power boosting along with codec rate selection, based on frame structure and the modulation used by the BS for a particular user. Once the codec rate is indicated, then the user may directly understand the TBS, modulation etc. without much signalling. Several codecs are possible ranging from 4 kbps to 48 kbps and more. This defines the voice quality. Either an explicit value may be indicated to the UE or an index from a table to employ a specific codec rate is indicated to each UE via UE specific or group-common or UE common signalling methods.

In another embodiment, a lower code-rates are used. Since the users' SNRs are expected to be significantly low, and users' tx power in uplink is limited, the introduction of lower code-rates can enhance the coverage. A Channel quality indicator (CQI) is a four-bit value that conveys the channel quality in 16 levels/steps. The least operating SNR supported by current LTE/5G-NR CQI tables for eMBB is −6.9 dB. Hence, for the coverage enhancements, a new CQI entries is required for further lowering of SNR values. Based on this CQI report, the base station allocates the modulation and coding scheme (MCS) to a user. In LTE/5G-NR, this MCS is conveyed as a 5-bit value, and thus, the MCS look-up table has 32 entries. Similar to the CQI entries at lower SNRs, there is a need of new MCS entries for the lower SNRs as well.

Typically, the MCS tables are extrapolated from the code rates in CQI table. Each CQI entry is separated by 1.892 dB from one another in Table 2. The table 2 considers QPSK, 16 QAM, and 64 QAM modulation schemes. The entries introduced into the table are based on the link-level simulations for various code-rates and varying SNRs. At each SNR in the CQI table, the code-rate is chosen such that block error rate (BLER) at that code-rate is 10%. The following SE approximation is used for any given SINR and extrapolate the new CQI entries for obtaining lower code rates:

$$SE = 9.6 \times {10}^{- 5} \times {SINR}^{3} + 0.00533232 \times {SINR}^{2} + 9.89 \times 1 {0}^{- 2} \times SINR + 0.629993$$

The code rates and spectral efficiencies are calculated at every 1.892 dB and formulate new CQI table as shown in Table 3.

Since the CQI has to be conveyed through 4 bits, six new CQI entries for the lower SNRs are introduced by removing the CQI entries with 64 QAM. Here, the entries 1-12 are allowed to be either QPSK/BPSK. For a given number of resource block allocation, the QPSK is allowed to have half the code-rate of the BPSK. Thus, both the entries will have the same spectral efficiencies. Further, the current 5G-NR MCS table i.e. Table 4 is obtained by introducing a new code rate between every 2 CQI entries of Table 2. A similar procedure is followed with the new CQI table (Table 3) and formulate new MCS table (Table 5) supporting lower code rates.

The DCI formats will be changed to accommodate the new indication of larger number of CQI and MCS entries. This may be performed via RRC signaling as well in case of VOIP based mechanisms.

TABLE 2
Current CQI Table

| CQI | | code | |
|---|---|---|---|
| index | modulation | rate × 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 3
Proposed CQI Table

| | | Code- | | SNR |
|---|---|---|---|---|
| CQI | modulation | rate × 1024 | Efficiency | [BLER = 0.1] |
| 0 | out of range | | | |
| 1 | QPSK/BPSK | 11/q | 0.0107 | −17.7 |
| 2 | QPSK/BPSK | 14/q | 0.0136 | −15.9 |
| 3 | QPSK/BPSK | 21/q | 0.0205 | −14.1 |
| 4 | QPSK/BPSK | 36/q | 0.0351 | −12.3 |
| 5 | QPSK/BPSK | 63/q | 0.0615 | −10.5 |
| 6 | QPSK/BPSK | 106/q | 0.1036 | −8.7 |
| 7 | QPSK/BPSK | 156/q | 0.1523 | −6.9 |
| 8 | QPSK/BPSK | 240/q | 0.2344 | −5.10 |
| 9 | QPSK/BPSK | 386/q | 0.3770 | −3.15 |
| 10 | QPSK/BPSK | 716/q | 0.6016 | −1.25 |
| 11 | QPSK/BPSK | 898/q | 0.8770 | −0.8 |
| 12 | QPSK/BPSK | 1204/q | 1.1758 | 2.7 |
| 13 | 16QAM | 378 | 1.4766 | 4.7 |
| 14 | 16QAM | 490 | 1.9141 | 6.55 |
| 15 | 16QAM | 616 | 2.4063 | 8.6 |

TABLE 4
Current MCS Table

| MCS | Modulation | Target | |
|---|---|---|---|
| Index | Order | code Rate | Spectral |
| I_{MCS} | Qₘ | R × 1024 | Efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | Reserved |
| 29 | 2 | Reserved |
| 30 | 4 | Reserved |
| 31 | 6 | Reserved |

TABLE 5
Proposed MCS Table

| MCS | | code- | |
|---|---|---|---|
| Index | Modulation | rate × 1024 | Efficiency |
| 0 | q | 11/q | 0.0107 |
| 1 | q | 12/q | 0.0117 |
| 2 | q | 14/q | 0.0136 |
| 3 | q | 17/q | 0.0166 |
| 4 | q | 21/q | 0.0205 |
| 5 | q | 28/q | 0.0273 |
| 6 | q | 36/q | 0.0351 |
| 7 | q | 49/q | 0.0478 |
| 8 | q | 63/q | 0.0615 |
| 9 | q | 84/q | 0.0820 |
| 10 | q | 106/q | 0.1036 |
| 11 | q | 131/q | 0.1279 |
| 12 | q | 156/q | 0.1523 |
| 13 | q | 198/q | 0.1934 |
| 14 | 2 | 120 | 0.2344 |
| 15 | 2 | 157 | 0.3066 |
| 16 | 2 | 193 | 0.3770 |
| 17 | 2 | 251 | 0.4902 |
| 18 | 2 | 308 | 0.6016 |
| 19 | 2 | 379 | 0.7402 |
| 20 | 2 | 449 | 0.8770 |
| 21 | 2 | 526 | 1.0273 |
| 22 | 2 | 602 | 1.1758 |
| 23 | 2 | 679 | 1.3262 |
| 24 | 4 | 378 | 1.4766 |
| 25 | 4 | 434 | 1.6953 |
| 26 | 4 | 490 | 1.9141 |
| 27 | 4 | 553 | 2.1602 |
| 28 | 4 | 616 | 2.4063 |

| | | |
|---|---|---|
| 29 | q | reserved |
| 30 | 2 | reserved |
| 31 | 4 | reserved |

On embodiment of the present disclosure relate to Physical Uplink Control Channel (PUCCH) coverage enhancement. Currently in 5G NR PUCCH resources are assigned in a semi-static manner. To allow for coverage extension of PUCCH, dynamic repetitions, dynamic resources, dynamic resource sets for PUCCH may be allowed. Indicated via DCI/MAC or implicitly understood by user shall be supported. Pi/2 BPSK and QPSK when used for PUCCH may be allowed for power boosting based on the total UL transmission duration used by the UE. Similar to before, the power boosting can be made modulation-based, time-based i.e., frame structure and also frequency allocation based.

Annex-1

The UE shall first determine the number of REs (N_{RE}) within the slot.
A UE first determines the number of REs allocated for PDSCH within a PRB (N′_{RE}) by N′_{RE}=N_{sc}^{RB}·N_{symb}^{sh}−N_{DMRS}^{PRB}−Nₒₕ^{PRB}, where N_{sc}^{RB}=12 is the number of subcarriers in a physical resource block, N_{symb}^{sh} is the number of symbols of the PDSCH allocation within the slot, N_{DMRS}^{PRB} is the number of REs for DM-RS per PRB in the scheduled duration including the overhead of the DM-RS CDM groups without data, as indicated by DCI format 1_1 or as described for format 1_0 in Subclause 5.1.6.2, and Nₒₕ^{PRB} is the overhead configured by higher layer parameter xOverhead in PDSCH-ServingCellConfig. If the xOverhead in PDSCH-ServingCellconfig is not configured (a value from 0, 6, 12, or 18), the Nₒₕ^{PRB} is set to 0. If the PDSCH is scheduled by PDCCH with a CRC scrambled by SI-RNTI, RA-RNTI or P-RNTI, Nₒₕ^{PRB} is assumed to be 0.
A UE determines the total number of REs allocated for PDSCH (N_{RE}) by N_{RE}=min(156,N′_{RE})·n_{PRB}, where n_{PRB} is the total number of allocated PRBs for the UE.
2) Intermediate number of information bits (N_{info}) is obtained by N_{inf o}=N_{RE}·R·Qₘ·v.
If N_{inf o}≤3824
   Use step 3 as the next step of the TBS determination else
   Use step 4 as the next step of the TBS determination end if
3) When N_{inf o}≤3824, TBS is determined as follows
quantized intermediate number of information bits

$${N}_{info}^{′} = max ( 24 , {2}^{n} \cdot ⌊ \frac{{N}_{info}}{{2}^{n}} ⌋ ) ,$$

where

$$n = max ( 3 , ⌊ {log}_{2} ( {N}_{info} ) ⌋ - 6 ) .$$

use Table 6 find the closest TBS that is not less than N′_{inf o}.

TABLE 6
TBS for N_{inf o} ≤ 3824

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

4) When N_{inf o}>3824, TBS is determined as follows.
quantized intermediate number of information bits

$${N}_{info}^{′} = max ( 3840 , {2}^{n} \times round ( \frac{{N}_{info} - 24}{{2}^{n}} ) ) ,$$

where n=└log₂(N_{inf o}−24)┘5 and ties in the round function are broken towards the next largest integer.

```
if R ≤ 1/4
  $TBS = 8 \cdot C \cdot ⌈ \frac{{N}_{info}^{{}_{} ′} + 24}{8 \cdot C} ⌉ - 24 , where C = ⌈ \frac{{N}_{info}^{{}_{} ′} + 24}{3816} ⌉$
else
  if N′_{info} > 8424
    $TBS = 8 \cdot C \cdot ⌈ \frac{{N}_{info}^{{}_{} ′} + 24}{8 \cdot C} ⌉ - 24 , where C = ⌈ \frac{{N}_{info}^{{}_{} ′} + 24}{8424} ⌉$
  else
    $TBS = 8 \cdot ⌈ \frac{{N}_{info}^{{}_{} ′} + 24}{8} ⌉ - 24$
  end if
end if
```

else if Table 7 is used and 28≤I_{MCS}≤31,
the TBS is assumed to be as determined from the DCI transported in the latest PDCCH for the same transport block using 0≤I_{MCS}≤27. If there is no PDCCH for the same transport block using 0≤I_{MCS}≤27, and if the initial PDSCH for the same transport block is semi-persistently scheduled, the TBS shall be determined from the most recent semi-persistent scheduling assignment PDCCH.
   else
the TBS is assumed to be as determined from the DCI transported in the latest PDCCH for the same transport block using 0≤I_{MCS}≤28. If there is no PDCCH for the same transport block using 0≤I_{MCS}≤28, and if the initial PDSCH for the same transport block is semi-persistently scheduled, the TBS shall be determined from the most recent semi-persistent scheduling assignment PDCCH.

TABLE 7
MCS index table 2 for PDSCH

| MCS Index | Modulation | Target code Rate | Spectral |
|---|---|---|---|
| I_{MCS} | Order Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

The UE is not expected to receive a PDSCH assigned by a PDCCH with CRC scrambled by SI-RNTI with a TBS exceeding 2976 bits.

For the PDSCH assigned by a PDCCH with DCI format 1_0 with CRC scrambled by P-RNTI, or RA-RNTI, TBS determination follows the steps 1-4 with the following modification in step 2: a scaling N_{inf o}=S·N_{RE}·R·Qₘ·v is applied in the calculation of N_{info}, where the scaling factor is determined based on the TB scaling field in the DCI as in Table 8.

TABLE 8
Scaling factor of N_{info} for P-RNTI and
RA-RNTI

| TB scaling field | Scaling factor S |
|---|---|
| 00 | 1 |
| 01 | 0.5 |
| 10 | 0.25 |
| 11 | |

The NDI and HARQ process ID, as signaled on PDCCH, and the TBS, as determined above, shall be reported to higher layers.

Annex-2

TABLE 9
MCS index table for PUSCH with transform precoding and 64QAM

| MCS | Modulation | Target | |
|---|---|---|---|
| Index | Order | code Rate | Spectral |
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | Reserved |
| 31 | 6 | reserved |

TABLE 10
MCS index table 2 for PUSCH with transform precoding and 64QAM

| MCS | Modulation | | |
|---|---|---|---|
| Index | Order | Target code Rate | Spectral |
| I_{MCS} | Qₘ | R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

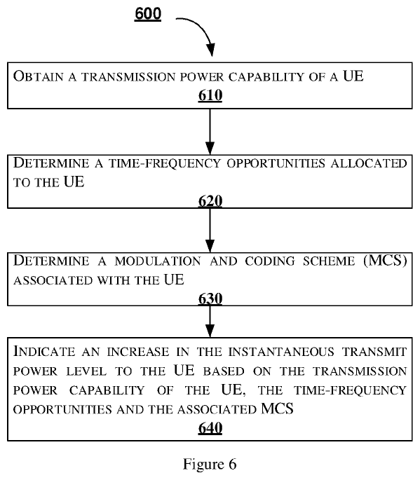

FIG. 6 shows a flowchart illustrating for improving coverage of a cellular system, in accordance with some embodiments of the present disclosure.

As illustrated in FIG. 6, the method 600 comprises one or more blocks of a base station (BS) for improving coverage of a cellular system. The method 600 may be described in the general context of computer executable instructions. Generally, computer executable instructions can include routines, programs, objects, components, data structures, procedures, modules, and functions, which perform functions or implement abstract data types.

The order in which the method 600 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 610, obtaining, by a base station (BS), a transmission power capability of a user equipment (UE). The transmission power capability is a function of the MCS.

At block 620, determining, by the BS, a time-frequency opportunities allocated to the UE. The time-frequency opportunities comprise one of contiguous and dis-contiguous transmission opportunities in time.

At block 630, determining, by the BS, a modulation and coding scheme (MCS) associated with the UE. The modulation scheme is one of a binary phase shift keying (BPSK), a pi/2 BPSK, a Quadrature Phase Shift Keying (QPSK) and a quadrature amplitude modulation (QAM).

At block 640, indicating, by the BS, an increase in the instantaneous transmit power level to the UE based on the transmission power capability of the UE, the time-frequency opportunities and the associated MCS.

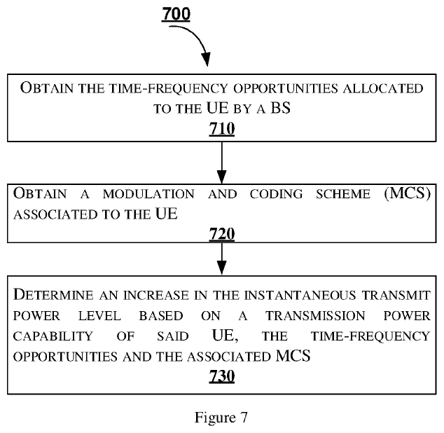

FIG. 7 shows a flowchart illustrating for improving coverage of a cellular system, in accordance with some embodiments of the present disclosure.

As illustrated in FIG. 7, the method 700 comprises one or more blocks of user equipment (UE) for improving coverage of a cellular system. The method 700 may be described in the general context of computer executable instructions. Generally, computer executable instructions can include routines, programs, objects, components, data structures, procedures, modules, and functions, which perform functions or implement abstract data types.

The order in which the method 700 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 710, obtaining, by a user equipment (UE), the time-frequency opportunities allocated to the UE by a base station (BS). The time-frequency opportunities comprise one of contiguous and dis-contiguous transmission opportunities in time

At block 720, obtaining, by the UE, a modulation and coding scheme (MCS) associated to the UE. The modulation scheme is one of a binary phase shift keying (BPSK), a pi/2 BPSK, a Quadrature Phase Shift Keying (QPSK) and a quadrature amplitude modulation (QAM).

At block 730, determining, by the UE, an increase in the instantaneous transmit power level based on a transmission power capability of said UE, the time-frequency opportunities and the associated MCS. The transmission power capability is a function of the MCS.

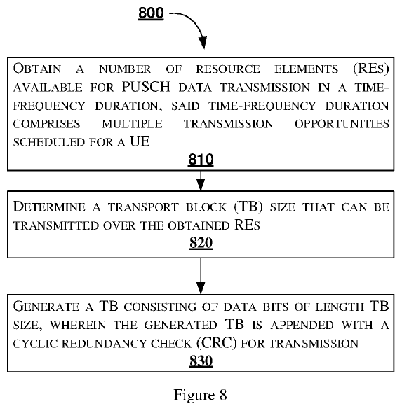

FIG. 8 shows a flowchart illustrating for improving coverage of a cellular system, in accordance another embodiments of the present disclosure.

As illustrated in FIG. 8, the method 800 comprises one or more blocks of a communication system for improving coverage of a cellular system. The method 800 may be described in the general context of computer executable instructions. Generally, computer executable instructions can include routines, programs, objects, components, data structures, procedures, modules, and functions, which perform functions or implement abstract data types.

The order in which the method 800 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 810, obtaining, by a communication system, a number of resource elements (REs) available for PUSCH data transmission in a time-frequency duration, said time-frequency duration comprises multiple transmission opportunities scheduled for a user equipment (UE).

At block 820, determining, by the communication system, a transport block (TB) size that can be transmitted over the obtained REs.

At block 830, generating, by the communication system, a TB consisting of data bits of length TB size, wherein the generated TB is appended with a cyclic redundancy check (CRC) for transmission. The generated TB is encoded using a channel encoder.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1-24. (canceled)

25. A base station (BS), the BS comprising:
a channel codec operable to adaptively allocate a transmit power level to a user equipment device (UE) according to changes in:
a transmission power capability of the UE,
time-frequency resources assigned to the UE, and
a modulation and coding scheme (MCS) of the UE; and
a transmitter operable to indicate the transmit power level to the UE.

26. The BS of claim 25, wherein the transmission power capability is a function of the MCS.

27. The BS of claim 25, wherein the time-frequency resources comprises one of contiguous transmission resources in time and discontiguous transmission resources in time.

28. The BS of claim 25, wherein the modulation scheme is one of a binary phase shift keying (BPSK), a pi/2 BPSK, a Quadrature Phase Shift Keying (QPSK) and a quadrature amplitude modulation (QAM).

29. The BS of claim 25, wherein:
a duration of the one or more time-frequency resources comprises a frequency allocation in terms of one of subcarriers, resource block (RB), sub-bands or resource block groups (RBGs), and
the duration is indicated to the UE.

30. The BS of claim 25, wherein the BS is operable to:
obtain a number of resource elements (REs) for a physical uplink shared channel (PUSCH) data transmission over one or more transmission resources;
determine a transport block (TB) size that can be transmitted over the obtained REs; and
generate a TB consisting of data bits of length TB size.

31. The BS of claim 30, wherein:
the number of REs accounts for a number of reference signals (RSs) over the duration.

32. The BS of claim 30, wherein:
an RS is used across the one or more transmission resources according to the UE capability,
the UE capability indicates an ability to maintain transmission parameters over the one or more transmission resources, and
the transmission parameters comprise a phase coherence of a transmitter.

33. The BS of claim 30, wherein:
a location of an RS for the one or more transmission resources is indicated to the UE.

34. The BS of claim 30, wherein:
the MCS is used for the transmission of the TB, and
the MCS is selected from a MCS table for achieving optimized signal to noise ratio (SNR) conditions for an extreme coverage.

35. The BS of claim 30, wherein:
the number of REs is determined using one or more symbols in uplink slots.

36. The BS of claim 30, wherein:
a scaling factor is used to determine the TB size,
the scaling factor is the number of transmission resources given to the UE, and
the scaling factor is indicated to the UE in one of a dynamic and a semi-static manner.

37. The BS of claim 30, wherein:
the determined TB is transmitted with a different redundancy via different transmission resources.

38. The BS of claim 30, wherein:
the UE does not transmit in a transmission resource if it is determined that the transmission resource collides with a higher priority transmission.
